(19) United States
(12) Patent Application Publication
(10) Pub. No.: US 2008/0212683 A1
(43) Pub. Date: Sep. 4, 2008

(54) Image Decoding Device, Image Encoding Device and System LSI

(76) Inventors: Hiroaki Nakata, Yokohama (JP); Takafumi Yuasa, Yokohama (JP); Fumitaka Izuhara, Kokubunji (JP); Kazushi Akie, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/939,807

(22) Filed: Nov. 14, 2007

(30) Foreign Application Priority Data
Nov. 14, 2006 (JP) 2006-308253

(51) Int. Cl. G06K 9/36

(52) U.S. Cl. 375/240.23; 382/251; 375/E07.267

(57) ABSTRACT

An image decoding device according to the present invention is an image decoding device responding to decoding of an image encoding method selecting an encoding table and an encoding format to use according to the kind of a parameter included in encoded data and comprises a bit stream processing unit converting a bit stream of the encoded data into an intermediate format and an image processing unit decoding data converted into the intermediate format and converting the same into image data. The bit stream processing unit and the image processing unit start independently. An image encoding device according to the present invention, in the same manner, comprises an image processing unit converting image data to be encoded into an intermediate format and a bit stream processing unit encoding the data converted into the intermediate format and converting the same into a bit stream. Thereby, image encoding and decoding processings with a low operation frequency and low power consumption is realized.

### CROSS-REFERENCE TO RELATED APPLICATION

The present application claims priority from Japanese Patent Application No. JP 2006-308253 filed on Nov. 14, 2006, the content of which is hereby incorporated by reference into this application.

### BACKGROUND OF THE INVENTION

The present invention relates to an image decoding device, an image encoding device and a system LSI decoding or encoding an image signal, in particular, to technique effectively applied to reduction of an operation frequency thereof and reduction of power consumption.

Conventionally, as technique for decoding or encoding of an image signal, there is one method disclosed in Japanese Patent Application Laid-Open Publication No. 2003-259370. In this conventional-art document, a method in which an intermediate code is used between a variable-length encoding/decoding means and an image encoding/decoding means and a buffer for the intermediate code is prepared, and therefore, a variable-length encoding processing and another processing can be executed in parallel and an image encoding/decoding processing with low power consumption can be realized is disclosed.

### SUMMARY OF THE INVENTION

In Patent Document 1, parallel execution of the variable-length encoding processing and another processing is realized on the premise of an image encoding method in which one variable-length code table is used to all parameters in an image encoding signal. However, in the image compression technique standards employed at present, such as MPEG-2, MPEG-4, VC-1, H.264 and the like mainly, since the variable-length code table is selected according to the kind of a parameter or an encoding method requiring no variable-length encode table is selected, the method disclosed in Patent Document 1 cannot cope with these standards.

Accordingly, an object of the present invention is to provide an image decoding device and an image encoding device realizing an image encoding/decoding processing with a low operation frequency and low power consumption by enabling parallel execution of the variable-length encoding processing and another processing in the image compression technique in which the variable-length code table is selected according to the kind of the parameter or an encoding method requiring no variable-length code table is selected.

The typical ones of the inventions disclosed in this application will be briefly described as follows.

The image decoding device according to the present invention is an image decoding device which responds to decoding of an image encoding method selecting a code table and an encoding format according to the kind of a parameter included in encoded data and using the same. In the image decoding device, a bit stream processing unit converting a bit stream of the encoded data into an intermediate format and an image processing unit decoding the data converted into the intermediate format and converting the same into image data are provided and the bit stream processing unit and the image processing unit start independently.

Further, the image encoding device according to the present invention is an image encoding device which responds to encoding of an image encoding method selecting a code table and an encoding format according to the kind of a parameter included in encoded data and using the same. In the image encoding device, an image processing unit converting image data to be encoded into the intermediate format and a bit stream processing unit encoding the data converted into the intermediate format and converting the same into a bit stream are provided and the image processing unit and the bit stream processing unit start independently.

The effects obtained by typical aspects of the present invention will be briefly described below.

According to the present invention, in the image compression technique in which a variable-length code table is selected according to the kind of a parameter or the variable-length code table is not required, such as MPEG-2, MPEG-4, VC-1, H.264 and the like, parallel operation of the bit stream processing unit and the image processing unit becomes possible and operation frequencies of the image decoding device and the image encoding device can be suppressed, as a result, the power consumption can be reduced.

In particular, since it is possible to operate and start the bit stream processing unit and the image processing unit independently, appropriate processing times can be allocated for the respective processings by controlling start timings thereof and peak processing performance can be suppressed, as a result, it is possible to suppress an operation frequency necessary for processing an identical image to a fraction of that of the conventional art.

### BRIEF DESCRIPTIONS OF THE DRAWINGS

FIG. 1 is a structural diagram showing a structure of an image decoding device according to a first embodiment of the present invention;

FIG. 2 is a diagram showing a structural example of a bit stream of an intermediate code of the image decoding device according to the first embodiment of the present invention;

FIG. 3 is a diagram showing a structural example of a macro block parameter set of the bit stream of the intermediate code of the image decoding device according to the first embodiment of the present invention;

FIG. 4 is a diagram showing a structural example of level information to be encoded to the intermediate code of the image decoding device according to the first embodiment of the present invention;

FIG. 5 is a diagram showing a structure of an Exp-Golomb-code of the image decoding device according to the first embodiment of the present invention;

FIG. 6 is a diagram showing a part of relation between a bit sequence of the Exp-Golomb-code and codeNum of the image decoding device according to the first embodiment of the present invention;

FIG. 7 is a diagram showing relation between codeNum for a signed Exp-Golomb-code and a value of the image decoding device according to the first embodiment of the present invention;

FIG. 8 is a diagram showing an example of relation of operation timings of a bit stream decoding processing unit and an image decoding synchronization processing unit in the image decoding device according to the first embodiment of the present invention;

FIG. 9 is a structural diagram showing a structure of an image encoding device according to a second embodiment of the present invention;

FIG. 10 is a diagram showing an example of relation of operation timings of an image encoding synchronization processing unit and a bit stream encoding processing unit in the image encoding device according to the second embodiment of the present invention; and

FIG. 11 is a structural diagram showing a structure of an image decoding device according to a third embodiment of the present invention.

### DESCRIPTIONS OF THE PREFERRED EMBODIMENTS

Hereinafter, embodiments of the present invention will be described in detail with reference to the accompanying drawings. Note that the same components are denoted by the same reference symbols throughout the drawings for describing the embodiment, and the repetitive description thereof will be omitted.

### First Embodiment

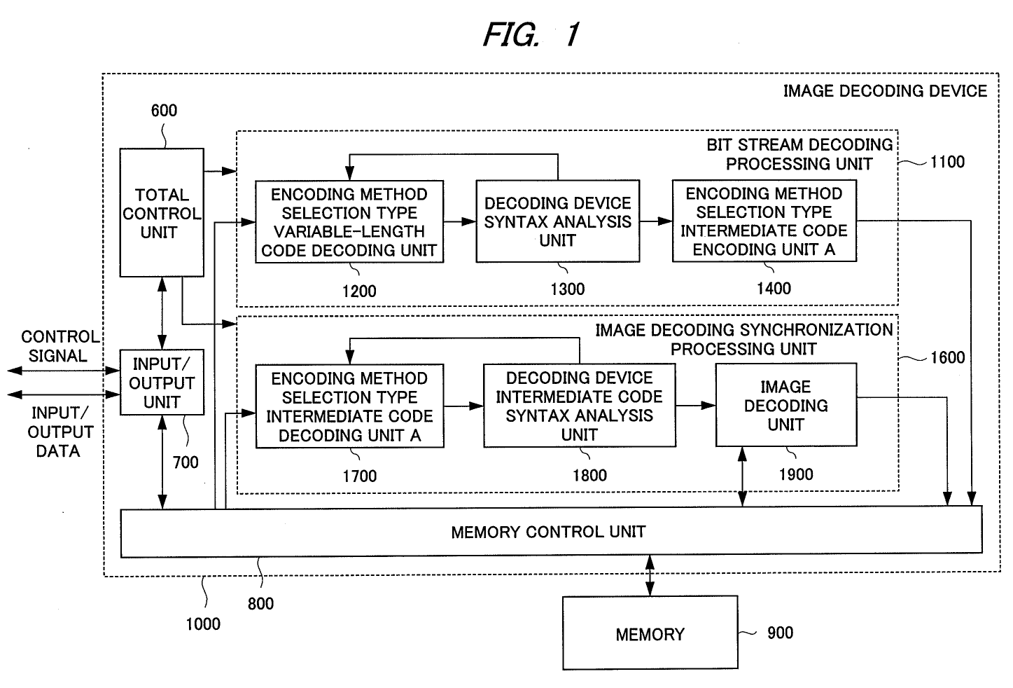

With reference to FIG. 1, a structure and operation of an image decoding device according to a first embodiment of the present invention are explained hereinafter. FIG. 1 is a structural diagram showing the structure of the image decoding device according to the first embodiment of the present invention.

In FIG. 1, inside an image decoding device 1000, a bit stream decoding processing unit 1100 as a bit stream processing unit, an image decoding synchronization processing unit 1600 as an image processing unit, an input/output unit 700, a total control unit 600 and a memory control unit 800 exist.

A bit stream of an encoded image is sent from outside to the memory control unit 800 via the input/output unit 700 and stored once in a memory 900.

At a stage when the bit stream of the encoded image necessary for a processing of a picture unit is stored in the memory 900, a control signal is inputted from outside and start of the bit stream decoding processing unit 1100 is requested to the total control unit 600 via the input/output unit 700. Based on this request, the total control unit 600 starts the bit stream decoding processing unit 1100.

The bit stream decoding processing unit 1100, on getting started, reads the bit stream of the encoded image from the memory 900 via the memory control unit 800, generates a bit stream of an intermediate code and outputs the same to the memory 900 via the memory control unit 800.

At this time, the bit stream of the intermediate code is written into an area different from that in which the bit stream of the encoded image before the processing is stored in the memory 900, so that the bit stream of encoded images is not overwritten.

At a stage when all the bit streams of the encoded image necessary for a processing of a picture unit are converted into the bit streams of the intermediate code, a control signal is inputted from outside and start of the image decoding synchronization processing unit 1600 is requested to the total control unit 600 via the input/output unit 700. Based on this request, the total control unit 600 starts the image decoding synchronization processing unit 1600.

The image decoding synchronization processing unit 1600, on getting started, reads the bit stream of the intermediate code from the memory 900 via the memory control unit 800, converts the same into decoded image data and stores the same into the memory 900 via the memory control unit 800. At this moment, the decoded image data is written into an area different from that in which the bit stream of the encoded image before the processing and the bit stream of the intermediate code are stored in the memory 900, so that these bit streams are not overwritten.

As soon as the generation processing of the bit stream of the intermediate code of a certain picture is completed, a processing of the next picture becomes executable in the bit stream decoding processing unit 1100, and therefore, as soon as the bit stream of the encoded image necessary for the processing of the next picture is stored from outside into the memory 900, a control signal starting the bit stream decoding processing unit 1100 is inputted from outside again and the bit stream decoding processing unit 1100 and the image decoding synchronization processing unit 1600 are made to operate in parallel as much as possible. The operation storing the bit stream of the encoded image from outside to the memory 900 is executed during the processing of the previous picture.

In practice, for the parallel operation, it is necessary to manage a storage area in the memory 900 so that inputted data necessary for respective processings and a result of a processing that may be referred to later are not overwritten.

This memory management is performed in outside of the image decoding device 1000 and information about which memory area to be used is given from the outside when starting the bit stream decoding processing unit 1100 and the image decoding synchronization processing unit 1600.

Therefore, in a case where the area to store the bit stream of the encoded image, the bit stream of the intermediate code or the decoded image cannot be secured according to usage of the memory 900, it is necessary to temporarily stop the start of the bit stream decoding processing unit 1100 and the image decoding synchronization processing unit 1600 until the memory area can be secured again by completing reading of the decoded image from outside or completing the processing of the bit stream of the encoded image and the bit stream of the intermediate code.

Accordingly, in order to obtain the maximum performance of the image decoding device 1000, it is necessary that the memory 900 has enough capacity. That is, by performing start timing control of the bit stream decoding processing unit 1100 and the image decoding synchronization processing unit 1600 and memory management from outside, it is possible to consider balance of the capacity of the memory 900 and the processing performance of the image decoding device 1000 with respect to a system structure.

Inside the bit stream decoding processing unit 1100, an encoding method selection type variable-length code decoding unit 1200, a decoding device syntax analysis unit 1300 as a syntax analysis unit and an encoding method selection type intermediate code encoding unit A 1400 exist.

In the image compression technique standards such as MPEG-2, MPEG-4, VC-1, H.264 and the like, since different variable-length codes and fixed length codes of different lengths are used according to the kind of a parameter (for example, a value of a movement vector and a value of DCT coefficient-related information), if it cannot be determined which parameter the next coming bit sequence is, decoding of a code cannot be executed and even a boundary between a certain code and the next code cannot be determined.

Further, even in the same parameters, according to a value condition and the like, there is a case in which a code showing that the value is special comes first instead of a code obtained by encoding the value and a code representing the value in a different encoding method comes next. Thus, there is a complicated syntax regulation which causes omission in parameter coming order or parameters. The decoding device syntax analysis unit 1300 determines an encoding method of the next coming bit sequence from the bit stream of the encoded image, based on these syntax regulations.

That is, the decoding device syntax analysis unit 1300 determines the kind of a parameter decoded at present and judges the encoding method of a bit sequence based on this, and based on this judgment result, the encoding method selection type variable-length code decoding unit 1200 decodes the bit sequence. Further based on this result, the operation to judge the kind of the next parameter and the next encoding method of is repeated. As for details of the syntax regulation, specifications are released as the standards of respective image compression techniques, and therefore, explanations thereof are omitted herein.

Further, the decoding device syntax analysis unit 1300 carries out operations such as getting together a plurality of parameters obtained by decoding by the encoding method selection type variable-length code decoding unit 1200 into one parameter according to a syntax structure of an intermediate code and exchanging order of parameters and sends a value of the parameter and selection information of the encoding method to the encoding method selection type intermediate code encoding unit A 1400 in order suited for the syntax structure of the intermediate code.

A structural example of an intermediate code is described later, meanwhile, in consideration of a data amount of the intermediate code and the processing of reading the intermediate code by the image decoding synchronization processing unit 1600, the encoding method is selected depending upon the kind of parameter also in the intermediate code.

The encoding method selection type variable-length code decoding unit 1200 determines a length of a bit sequence of a parameter corresponding to one element of syntax with reference to a table or according to a certain regulation and obtains a value decoded from the bit sequence based on a parameter encoding method determined by the decoding device syntax analysis unit 1300 based on the standard of the image compression technique. At the same time, the bit stream of the encoded image is read by the determined length. In a case of reference to the table, the table determined by the decoding device syntax analysis unit 1300 is used. As for the table referred to at encoding of a bit sequence and a certain regulation, specifications of the standards of respective image compression techniques have description thereof, and therefore, explanations are omitted herein.

The encoding method selection type intermediate code encoding unit A 1400 is an encoding method selection type intermediate code encoding unit for the image decoding device 1000 and outputs an intermediate code based on the value of the parameter and the encoding method sent from the decoding device syntax analysis unit 1300.

Inside the image decoding synchronization processing unit 1600, an encoding method selection type intermediate code decoding unit A 1700, a decoding device intermediate code syntax analysis unit 1800 and an image decoding unit 1900 exist. The image decoding synchronization processing unit 1600 performs an entire processing according to operation of the image decoding unit 1900.

The encoding method selection type intermediate code decoding unit A 1700 is a unit decoding an intermediate code for the image decoding device 1000. Since the bit stream of the intermediate code changes the encoding method of the value for each kind of the parameter, a decoding processing corresponding to the encoding method designated for each parameter by the decoding device intermediate code syntax analysis unit 1800 is performed.

The decoding device intermediate code syntax analysis unit 1800 carries out syntax analysis of the bit stream of the intermediate code, and designates the encoding method corresponding to each parameter to the encoding method selection type intermediate code decoding unit A 1700. A result of decoding the parameter of the intermediate code is sent to the image decoding unit 1900, together with parameter kind information.

The image decoding unit 1900 rearranges the parameter obtained from the decoding device intermediate code syntax analysis unit 1800 for an image processing, and through a reverse quantization processing, reverse DCT or operation corresponding thereto, a movement compensation processing and the like, a decoded image is generated based on the image compression standard and outputted to the memory 900 via the memory control unit 800.

The image decoding unit 1900 carries out the processing by the macro block. The macro block is usually a unit obtained by division of an image into 16 pixels×16 pixels. Note that, the image decoding unit 1900 has a function to read data from the memory 900 via the memory control unit 800 in order to obtain a reference image and the like necessary for the movement compensation processing.

In a case where the image decoding device 1000 responds to a plurality of image compression standards, the image decoding unit 1900 changes the operation and the processing according to respective standards.

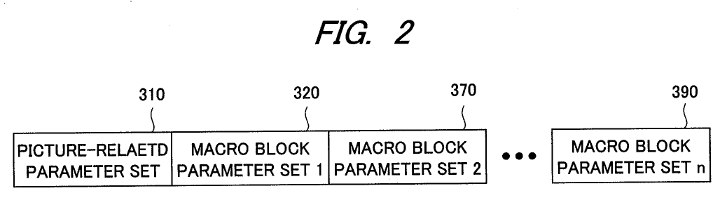

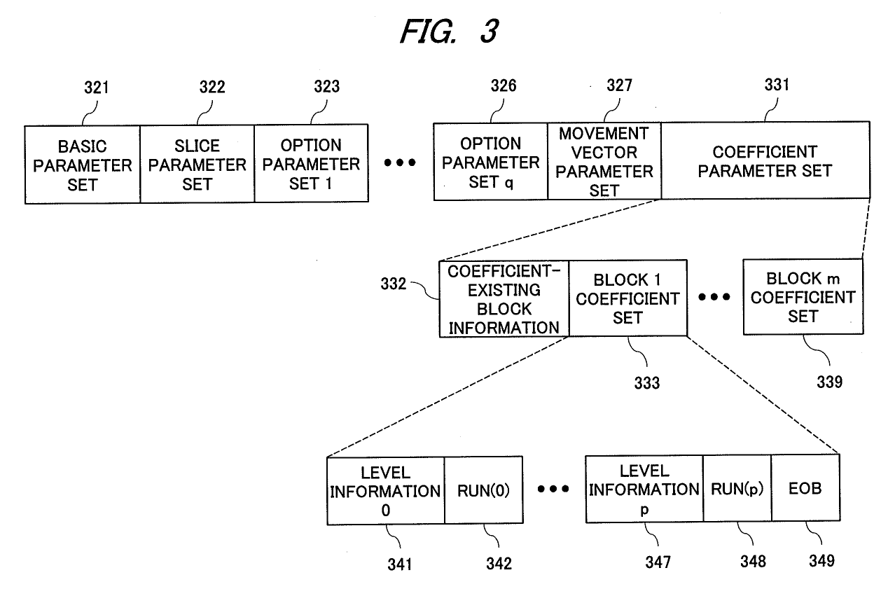

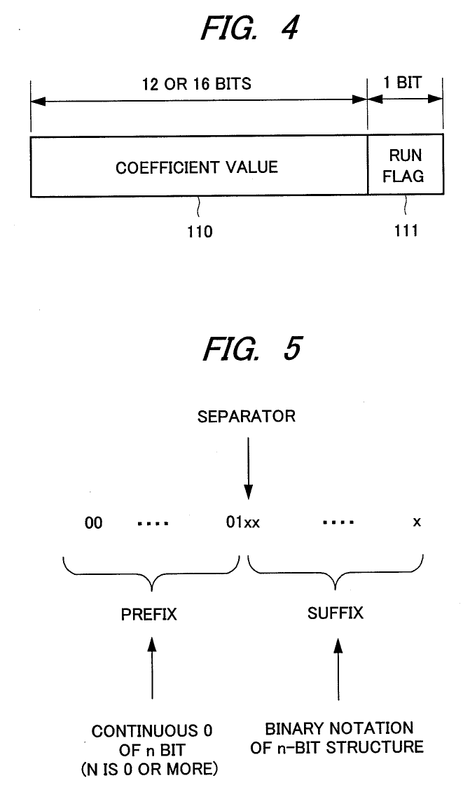

Next, with reference to FIG. 2 to FIG. 4, an example of the intermediate code of the image decoding device according to the first embodiment of the present invention is explained. FIG. 2 is a diagram showing a structural example of the bit stream of the intermediate code of the image decoding device according to the first embodiment of the present invention, FIG. 3 is a diagram showing a structural example of a macro block parameter set of the bit stream of the intermediate code of the image decoding device according to the first embodiment of the present invention and FIG. 4 is a diagram showing a structural example of level information to be encoded to the intermediate code of the image decoding device according to the first embodiment of the present invention.

As shown in FIG. 2, the bit stream of the intermediate code has a structure in which the macro block parameter sets in picture follow as many as the macro blocks structuring the picture after a picture-related parameter set 310.

The picture-related parameter set 310 is always structured of a fixed number of bits and stores information structuring parameters and pictures that do not change through the picture (numbers of macro blocks in vertical and horizontal). Each parameter is stored in a corresponding bit field in the picture-related parameter set 310.

In a case where the image decoding device 1000 responds to a plurality of image compression standards, the picture-related parameter set 310 has a structure like a highest common factor of the standards. That is, a parameter representing the same meaning among the standards are stored in the same bit field, a unique parameter of one standard is allotted to a dedicated bit field for the standard, and in a standard not using the parameter, the field is filled with 0 and the like and ignored.

And, the macro block parameter set is structured of a basic parameter set 321, a slice parameter set 322, an option parameter set 1 (323) to an option parameter set q (326), a movement vector parameter set 327 and a coefficient parameter set 331, as shown in FIG. 3. Note that, the basic parameter set 321 includes information of presence/absence of another parameter set and the information may be omitted in a parameter set other than the basic parameter set 321.

The basic parameter set 321 has information showing existing parameter set in the macro block among the slice parameter set 322, the option parameter set 1 (323) to the option parameter set q (326), the movement vector parameter set 327 and the coefficient parameter set 331 and makes the structuring parameter into an intermediate code with a fixed length code. In the image compression technique standards, there is a case in which all the parameters for a certain macro block are omitted, and in such a macro block, all of the option parameter set 1 (323) to the option parameter set q (326), the movement vector parameter set 327 and the coefficient parameter set 331 are omitted.

The slice parameter set 322 exists only in a macro block just after a border of slices when responding to the image compression technique having an idea of a slice, and exists only in a macro block at the head of the picture when responding to other image compression technique.

Here, the slice is a unit obtained by getting together one or more macro blocks. The slice parameter set 322 has a parameter common to the entire slice. Although a parameter structuring the slice parameter set 322 is also made into an intermediate code with a fixed length code, since the decoding device intermediate code syntax analysis unit 1800 always grasps the kind of the parameter of the intermediate code at intermediate code decoding, a bit length different from a parameter structuring the basic parameter set 321 can be employed.

In a case where the option parameter set 1 (323) to the option parameter set q (326) respond to a plurality of image compression technique standards, information necessary in respective standards peculiarly and information necessary in a case where the macro block type is a certain type (excluding the movement vector parameter set 327) are stored. Although there are many cases in which a plurality of macro blocks is used in the image compression technique standards and a necessary parameter may differ for each type, such a parameter is stored in the option parameter set as a parameter.

Although a parameter structuring the option parameter set is made into the intermediate code with fixed length code, since the decoding device intermediate code syntax analysis unit 1800 exists, a bit length necessary for each parameter can be allotted for each kind of the parameters.

The movement vector parameter set 327 stores a movement vector necessary for the movement compensation processing. Note that, usually, in the bit stream of the encoded image in the image compression technique standard, since a data amount is compressed by encoding difference information of a movement vector to store and the like, a value obtained by decoding the bit stream of the encoded image is only converted in an encoding method of the intermediate code as it is in the bit stream of the intermediate code, and thereby a data amount of the bit stream of the intermediate code is suppressed.

And, there is a case in which a plurality of movement vectors is included in the macro block, and in such a case, all the movement vectors are stored in order of existence in the bit stream of the encoded image. The number of movement vectors and related information thereto are separately stored as a parameter of the basic parameter set 321 or the option parameter set.

Since structure parameters of the movement vector parameter set 327 exist in a relatively-large number, a code composed of combination of an Exp-Golomb-code and a fixed length code (FLC) is used so that the data amount of bit stream of the intermediate code does not increase extremely with respect to the bit stream of the encode image. Hereinafter, in the present invention, the code composed of combination of the Exp-Golomb-code and the fixed length code (FLC) is referred to as an Exp-Golomb FLC combination code. As for the Exp-Golomb FLC combination code, description is made later.

The coefficient parameter set 331 is structured of coefficient-existing block information 332 and a block 1 coefficient set 333 to a block m coefficient set 339. A value of the coefficient-existing block information 332 has information determining a block in which a block coefficient set exists. A block having coefficient values of all 0 is handled as a non-existing block and a block coefficient set thereof is omitted.

The block is a unit obtained by dividing the macro block and corresponds to a unit of performing DCT operation or operation corresponding thereto. And a coefficient value is a value of a coefficient used in the DCT operation or the operation corresponding thereto. Although operation differs in each image compression technique standard and meaning of a coefficient may differ, a coefficient value decoded from the bit stream of the encoded image is merely encoded by an encoding method for the intermediate code and stored in the bit stream of intermediate codes, and the coefficient value itself is not converted.

And, as shown in FIG. 3, the structure of the block coefficient set has a structure in which parameters structuring the block coefficient set are generated by scanning a two-dimensional coefficient array necessary for the DCT operation or the operation corresponding thereto by a determined pattern and arranging the same in one-dimension, a coefficient of 0 is omitted, the number of coefficients omitted continuously before a non-omitted coefficient is obtained as RUN for each of non-omitted coefficients, information (level information) related to a value of the coefficient and the RUN are arranged alternately, and a code corresponding to EOB (End of Block) is putted at end. Note that, if the RUN is 0, the RUN is omitted.

The code corresponding to EOB uses level information with a coefficient value of 0. The pattern of scanning the two-dimensional coefficient array is the same as that of the standard of the image compression technique of decoding objective, in principle.

The level information before encoding as the bit sequence of the intermediate code has a structure shown in FIG. 4 in which a coefficient value is regarded as a signed integer and shifted to left by one bit, and a RUN flag 111 indicating whether there is a RUN corresponding to the level information or not is putted in a low 1 bit. The RUN flag 111 is set to 1 when the RUN exists and set to 0 when the RUN is omitted.

In decoding, by checking the RUN flag 111, it is possible to judge whether the RUN exists just after or not.

In the intermediate code, there is an advantage that the number of parameters obtained by adding the level information and the RUN included in one block coefficient does not exceed the number of coefficients necessary for the block configuration in any case, since the RUN is omitted when the RUN is 0.

Since parameters structuring the block coefficient set exist in an extremely large number, as the level information which is a structural element, a signed Exp-Golomb FLC combination code is used, and as the RUN, an unsigned Exp-Golomb FLC combination code is used.

Note that, in the Exp-Golomb FLC combination code, two parameters affecting upon a bit length and a structure of a code are used, and these parameters are selected appropriately by the movement vector parameter set 327, the level information and the RUN respectively. At decoding of the intermediate code, since the kind of the parameter under decoding can be recognized by the decoding device intermediate code syntax analysis unit 1800, this selection can be performed.

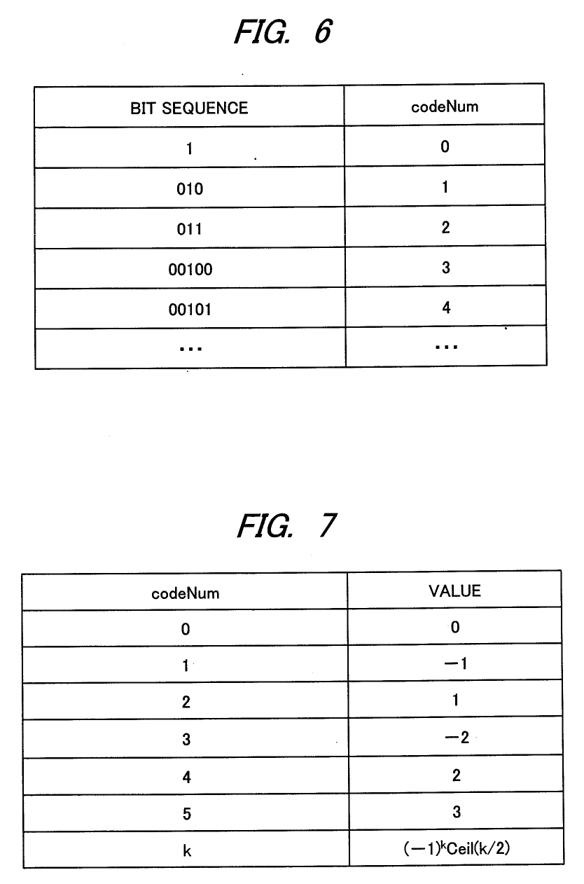

Here, the Exp-Golomb FLC combination code is explained. A Exp-Golomb-code which is an element of this code is a code used in the image compression technique standard H.264, and is a code in which the smaller the parameter value is, the shorter the number of bits necessary for the code becomes. The Exp-Golomb-code is described in the H.264 specifications and the details thereof are omitted herein, but with reference to FIG. 5 to FIG. 7, its outline is explained. FIG. 5 is a diagram showing a structure of an Exp-Golomb-code of the image decoding device according to the first embodiment of the present invention, FIG. 6 is a diagram showing a part of relation between a bit sequence of the Exp-Golomb-code of the image decoding device and codeNum according to the first embodiment of the present invention and FIG. 7 is a diagram showing relation between codeNum for a signed Exp-Golomb-code and a value of the image decoding device according to the first embodiment of the present invention.

The Exp-Golomb-code is, as shown in FIG. 5, structured of portions of a prefix, a separator and a suffix. The prefix portion is structured of a plurality of bits and all the bits are 0. The separator portion is always structured of one bit and a value thereof is 1. The suffix portion is structured of bits of the same number as the prefix portion and values of respective bits structuring the same are 0 or 1.

The relation between the bit sequence of the Exp-Golomb-code and codeNum has relation as shown in FIG. 6, and in an unsigned Exp-Golomb-code, the codeNum corresponds to a value of an unsigned integer.

The signed Exp-Golomb-code is handled with associating a value thereof with the codeNum in the relation shown in FIG. 7. In FIG. 7, a function Ceil( ) is a function that returns a minimum integer larger than a value given as an argument.

The relation between the codeNum and the value shown in FIG. 7 is relation obtained by reversing positive/negative relation in the signed Exp-Golomb-code used in the standard H.264, and lengths of bit sequences obtained by encoding by a positive value and a negative value having the same absolute values become the same.

The Exp-Golomb FLC combination code is an Exp-Golomb code in which an upper limit is set for a bit length of the prefix, when the bit length of the prefix of the Exp-Golomb-code is within the upper limit, expression in the same bit sequence as a normal Exp-Golomb-code is performed and when it exceeds the upper limit, expression in which the bit length of the prefix is set to the same as the upper limit, the separator is set to 0 and the codeNum is encoded at fixed length code to the suffix is performed.

That is, in the Exp-Golomb FLC combination code, the two parameters affecting upon the bit length and the structure of the code are the upper limit of the bit length of the prefix and a length of the fixed length code in a case where the suffix becomes the fixed length code.

In the Exp-Golomb-code, since all of a length of the prefix, a value of the suffix and the codeNum can be obtained by numeric operation, encoding and decoding can be performed without using a code table. And therefore, in the Exp-Golomb FLC combination code obtained by combining the Exp-Golomb-code and the fixed length code, encoding and decoding can be performed without using a code table, and logic of encoding and decoding can be realized in a small scale. Further, since a length of a bit sequence of an entire code can be calculated from the number of bits of 0 that continue from the head of the code, there is an advantage that a cut-out processing from the bit stream can be performed easily.

And, in the Exp-Golomb-code, a value close to 0 can be processed in a short bit length, but if the value becomes large, there is a disadvantage that a bit length of the prefix becomes long and the data amount becomes large. On the other hand, in the Exp-Golomb FLC combination code, there is an advantage that the bit length of the prefix is kept in a fixed range.

Since the bit stream of the intermediate code is generated by encoding a parameter by one of the fixed length code and the Exp-Golomb FLC combination code, a logic amount related to encoding and decoding of the intermediate code can be suppressed. And, since a parameter related to a movement vector and a coefficient is encoded by the Exp-Golomb FLC combination code, the data amount of the bit stream of the intermediate code can be suppressed to approximately several times with respect to the data amount of the bit stream of encoded image.

And, by advantages and characteristics of the intermediate code as mentioned above, the bit stream decoding processing unit 1100 and the image decoding synchronization processing unit 1600 can perform operations suitable for the respective processings.

Although the bit stream decoding processing unit 1100 has to perform processings for respective bits or respective parameters of an encoded image, by using the Exp-Golomb FLC combination code to portions of the movement vector parameter set 327 and the coefficient parameter set 331 occupying a large portion of the bit stream of the intermediate code, an increase ratio of a data amount of the bit stream of the encoded image and the bit stream of the intermediate code can be suppressed, and therefore, the operation can be optimized with bit processing operation as standard through input and output.

Since the image decoding synchronization processing unit 1600 operates in synchronized with the image decoding unit 1900, in order to achieve necessary performance stably, it is preferred that a processing is performed within predetermined time for each macro block structuring a decoded image.

At this processing, although the number of parameters read from the intermediate code for each macro block and processing time required for decoding each parameter may become bottlenecks, in the coefficient parameter set 331 in which the number of parameters may become large, the maximum number of parameters necessary is suppressed by omitting the RUN of value 0 and an encoding method for the bit stream is a fixed length code or an Exp-Golomb FLC combination code so that the processing can be performed relatively easily, and therefore, they hardly become bottlenecks.

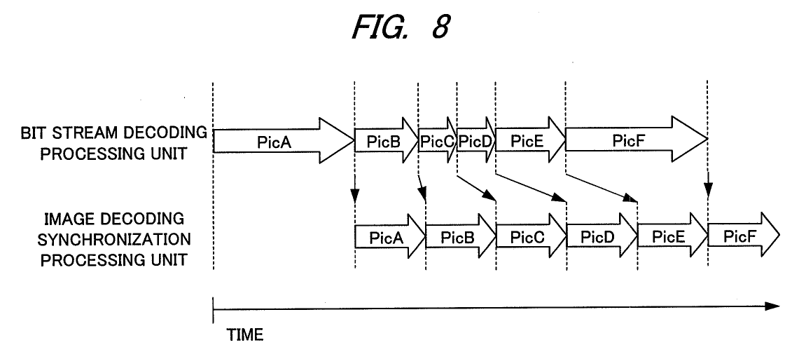

Next, with reference to FIG. 8, by use of above characteristics, a timing example of parallel operation of the bit stream decoding processing unit 1100 and the image decoding synchronization processing unit 1600 in the image encoding device according to the first embodiment of the present invention is explained. FIG. 8 is a diagram showing an example of relation of operation timings between the bit stream decoding processing unit and the image decoding synchronization processing unit in the image decoding device according to the first embodiment of the present invention.

FIG. 8 shows processing time of each picture in the bit stream decoding processing unit 1100 and the image decoding synchronization processing unit 1600, respectively.

In the image compression technique standards such as MPEG-2, MPEG-4, VC-1, H.264 and the like, a compression ratio is increased by prediction using correlation between pictures, but a picture not using the correlation between pictures is inserted once in several to several tens pictures normally. As a result, since the compression ratio is lowered in the picture not using the correlation between pictures, the data amount required in the bit stream of the encoded image is larger than that in pictures using the correlation.

Although depending upon the image, this ratio is approximately several times. As a result, the processing time of the bit stream decoding processing unit 1100 changes according to the picture. In the example in FIG. 8, it is assumed that pictures of Pic A and Pic F are pictures not using the correlation between pictures, and other pictures are pictures using the correlation.

On the other hand, in the image decoding synchronization processing unit 1600, since speed of reproducing pictures is normally a fixed interval, the processing time is constant in all pictures. In practice, in the image compression technique standards such as MPEG-2, MPEG-4, VC-1, H.264 and the like, since it is necessary to exchange decoding order and reproducing order partially, fluctuation of the processing time is permitted to some extent. But since data size of the decoded image is large, permissible fluctuation is small because of buffer capacity.

As shown in FIG. 8, the processing time from a picture not using the correlation between pictures to a next picture not using the correlation between pictures (from start of a Pic A processing to end of a Pic E processing in FIG. 8) is approximately the same in the bit stream decoding processing unit 1100 and the image decoding synchronization processing unit 1600.

Although this relation has fluctuation in practice, the maximum number of bits (maximum bit rate) usable in the bit stream of the encoded image of one second is defined in the image compression technique standard and the number of pictures reproduced in one second is normally determined such as 30 or 60, and therefore, in a case where the bit rate becomes maximum under these conditions, the processing time from picture not using the correlation between pictures to a next picture not using the correlation between pictures is approximately the same in the bit stream decoding processing unit 1100 and the image decoding synchronization processing unit 1600.

That is, in a case where the bit stream decoding processing unit 1100 and the image decoding synchronization processing unit 1600 cannot be started independently and are operated in synchronization, it is necessary to operate the entire in accordance with the image decoding synchronization processing unit 1600 because of the number of pictures reproduced in one second and it is necessary to design the bit stream decoding processing unit 1100 so as to process peak per picture of a bit stream data amount of the encoded image within the processing time of one picture.

Further, since the bit stream decoding processing must be performed in order from front and parallel operation is difficult, in order to increase processing performance, normally the operation frequency must be increased. As a result, the power consumption is increased.

However, as explained in the present embodiment, if the bit stream decoding processing unit 1100 and the image decoding synchronization processing unit 1600 can be started independently, peak performance of the bit stream decoding processing unit 1100 can be suppressed, and therefore, the operation frequency can be suppressed, as a result, the power consumption can be reduced.

And, a data amount related to the bit stream of the intermediate code is made so as not to be particularly large with respect to the bit stream of the encoded image in a rate, the encoding and decoding processings are made executable relatively easily without using a code table and the processing is made so that the parameter read processing per macro block is not a bottleneck when the image decoding synchronization processing unit 1600 reads the intermediate code. Thus, logic scale and operation speed of the image decoding synchronization processing unit 1600 are also taken into consideration, and therefore, the operation frequency can be suppressed as the entire image decoding device, as a result, the power consumption can be reduced.

### Second Embodiment

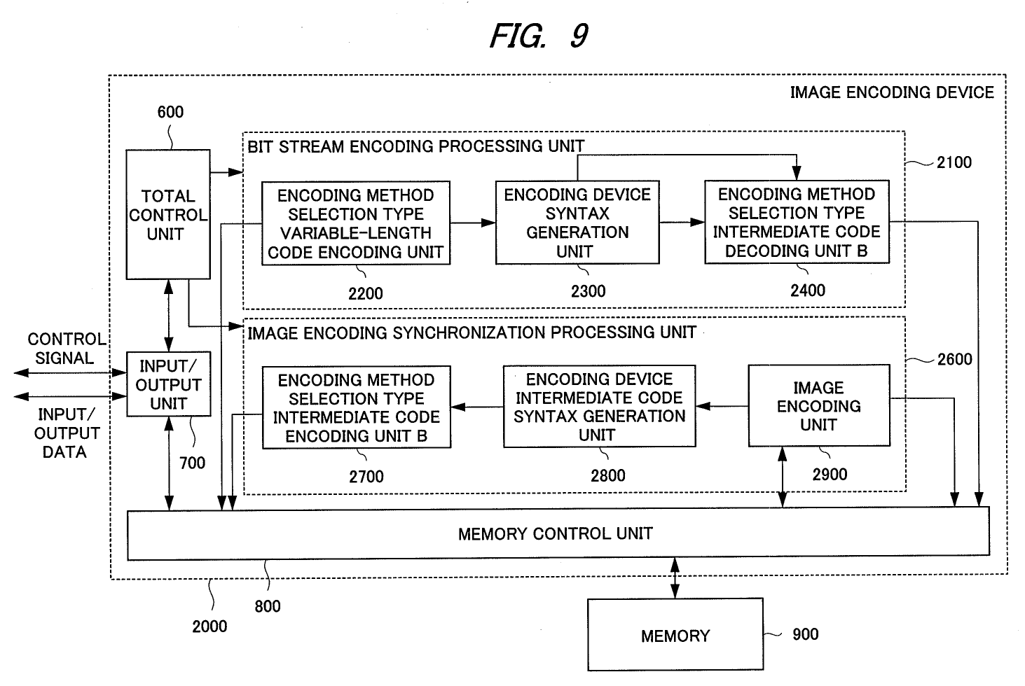

With reference to FIG. 9, a structure and operation of an image encoding device according to a second embodiment of the present invention are explained. FIG. 9 is a structural diagram showing the structure of the image encoding device according to the second embodiment of the present invention.

Basically, the image encoding device 2000 is one obtained by reversing a direction of data flow in the image decoding device 1000 shown in FIG. 1 of the first embodiment.

Inside the image encoding device 2000, a bit stream encoding processing unit 2100 as a bit stream encoding processing unit, an image encoding synchronization processing unit 2600 as an image processing unit, an input/output unit 700, a total control unit 600 and a memory control unit 800 exist.

Data of an image to be encoded is sent from outside to the memory control unit 800 via the input/output unit 700 and stored once in a memory 900.

At a stage where data of one picture is stored in the memory 900, a control signal is inputted from outside and start of the image encoding synchronization processing unit 2600 is requested to the total control unit 600 via the input/output unit 700. Based on this request, the total control unit 600 starts the image encoding synchronization processing unit 2600.

The image encoding synchronization processing unit 2600, on getting started, reads the data of the picture from the memory 900 via the memory control unit 800, converts the same into a bit stream of an intermediate code and stores the same to the memory 900 via the memory control unit 800.

At a stage where all of the data of the picture is converted into the bit stream of the intermediate code, a control signal is inputted from outside and start of the bit stream encoding processing unit 2100 is requested to the total control unit 600 via the input/output unit 700.

The bit stream encoding processing unit 2100, on getting started, reads the bit stream of the intermediate code from the memory 900 via the memory control unit 800, generates a bit stream of an encoded image to be a result of encoding and outputs the same to the memory via the memory control unit 800. At this time, the data is written into an area different from that in which the bit stream of the intermediate code before the processing is stored in the memory 900 so that the bit stream is not overwritten.

As soon as the bit stream generation processing of the intermediate code of a certain picture is completed, a processing of the next picture becomes executable in the image encoding synchronization processing unit 2600, and therefore, as soon as data of the next picture is stored into the memory 900 from outside, a control signal starting the image encoding synchronization processing unit 2600 is inputted from outside again and the bit stream encoding processing unit 2100 and the image encoding synchronization processing unit 2600 are made to operate in parallel as much as possible. The operation storing the data of the picture from outside is carried out during the processing of the previous picture.

In practice, for the parallel operation, it is necessary to manage a storage area in the memory 900 so that inputted data necessary for respective processings and a result of a processing that may be referred to later are not overwritten.

This memory management is performed in outside of the image encoding device 2000 and information about which memory area to be used is given from the outside when starting the bit stream encoding processing unit 2100 and the image encoding synchronization processing unit 2600. Therefore, in a case where the area to store the bit stream of the data of the picture to be encoded and the intermediate code and the bit stream of the encoded image which is a result of the encoding cannot be secured according to usage of the memory 900, it is necessary to temporarily stop the start of the bit stream encoding processing unit 2100 and the image encoding synchronization processing unit 2600 until the memory area can be secured again by completing reading of the result of the encoding from outside or completing the processing of the bit stream of the data of the picture to be encoded and the intermediate code.

Accordingly, in order to obtain the maximum performance of the image encoding device 2000, it is necessary that the memory 900 has enough capacity. That is, by performing start timing control of the bit stream encoding processing unit 2100 and the image encoding synchronization processing unit 2600 and memory management from outside, it is possible to consider balance of the capacity of the memory 900 and the processing performance of the image encoding device 2000 with respect to a system structure.

Inside the image encoding synchronization processing unit 2600, an encoding method selection type intermediate code encoding unit B 2700, an encoding device intermediate code syntax generation unit 2800 and an image encoding unit 2900 exist. The image encoding synchronization processing unit 2600 performs an entire processing in accordance with operation of the image encoding unit 2900.

The image encoding unit 2900 performs detection of a movement vector from the data of the picture to be encoded, generation of difference information, DCT operation or operation corresponding thereto, a quantization processing and the like based on the image compression technique standard and rearranges coefficient data after quantization for the bit stream of the intermediate code. The image encoding unit 2900 performs the processing by the macro block.

Note that, the image encoding unit 2900 has a function to read and write data with respect to the memory 900 via the memory control unit 800 in order to obtain a reference image necessary for the movement vector detection and output a reference image necessary for movement vector detection at another picture processing.

The encoding device intermediate code syntax generation unit 2800 performs syntax generation of the bit stream of the intermediate code and designates a parameter value and an encoding method for each parameter to the encoding method selection type intermediate code encoding unit B 2700.

The encoding method selection type intermediate code encoding unit B 2700 is a unit encoding the intermediate code for the image encoding device 2000. The bit stream of the intermediate code is the same format as that in the image decoding device 1000, and in order to change the encoding method of a value for each kind of the parameter, an encoding processing corresponding to the encoding method designated from the encoding device intermediate code syntax generation unit 2800 for each parameter is performed. The generated intermediate code is outputted to the memory 900 via the control unit 800.

In a case where the image encoding device 2000 responds to a plurality of image compression standards, the image encoding unit 2900 changes operation and a processing according to respective standards.

Inside the bit stream encoding processing unit 2100, an encoding method selection type variable-length code encoding unit 2200, an encoding device syntax generation unit 2300 as a syntax analysis unit and an encoding method selection type intermediate code decoding unit B 2400 exist.

The encoding method selection type intermediate code decoding unit B 2400 reads the bit stream of the intermediate code from the memory 900 via the memory control unit 800, performs decoding for each parameter and sends the result to the encoding device syntax generation unit 2300.

The encoding device syntax generation unit 2300 generates syntax based on the image compression technique standards such as MPEG-2, MPEG-4, VC-1, H.264 and the like, performs rearrangement, separation and reconstruction of the value obtained from the encoding method selection type intermediate code decoding unit B 2400 based on the syntax and sends the encoding method and the value corresponding to each parameter to the encoding method selection type variable-length code encoding unit 2200.

And, the encoding device syntax generation unit 2300 has a function to notify the encoding method of the intermediate code decoded at present to the encoding method selection type intermediate code decoding unit B 2400. Since the bit stream of the intermediate code uses different variable-length codes or fixed length codes of different lengths according to the kind of the parameter, if it cannot be judged which parameter the next coming bit sequence corresponds to, decoding of the code cannot be executed and a boundary between codes cannot be determined, and therefore, this function is required for the encoding device syntax generation unit 2300 managing syntax.

The encoding method selection type variable-length code encoding unit 2200 generates a bit sequence corresponding to one element of syntax from a value of the parameter with reference to a table or according to a certain regulation based on the encoding method of the bit sequence determined by the encoding device syntax generation unit 2300 based on the image compression technique standard. In a case where table reference is carried out, the table determined by the encoding device syntax generation unit 2300 is used.

As for the table and the certain regulation necessary for encoding of a bit sequence, description is made in specifications of each of the image compression technique standards, and therefore, explanations thereof are omitted herein. The generated bit sequence is stored into the memory 900 in order via the memory control unit 800.

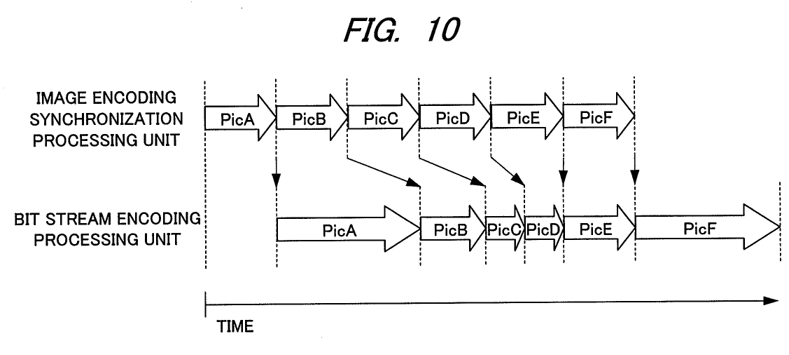

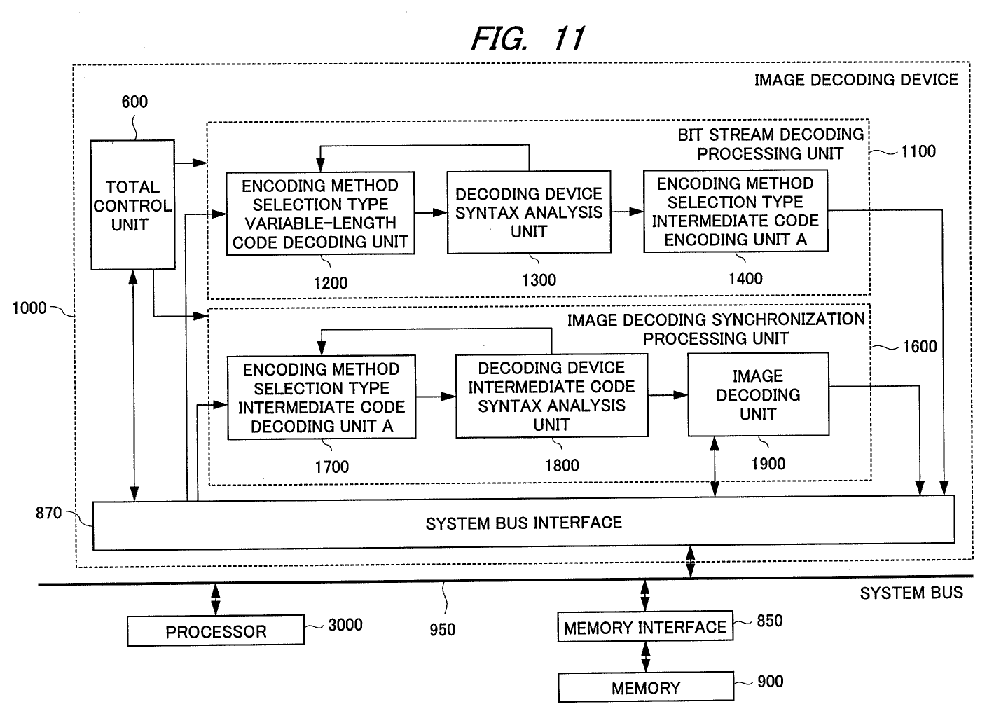

Next, with reference to FIG. 10, a timing example of parallel operation of the bit stream encoding processing unit 2100 and the image encoding synchronization processing unit 2600 in the image encoding device 2000 according to the second embodiment of the present invention is explained. FIG. 10 is a diagram showing an example of relation of operation timings between the image encoding synchronization processing unit and the bit stream encoding processing unit in the image encoding device according to the second embodiment of the present invention.

In FIG. 10, processing time for each picture is shown for the bit stream encoding processing unit 2100 and the image encoding synchronization processing unit 2600, respectively. In FIG. 10, it is assumed that encoding not using the correlation between the pictures is performed for Pic A and Pic F, and encoding using the correlation between the pictures is performed for other pictures.

Also in the image encoding processing, for the same reason as in the decoding processing, a data amount of the bit stream of the encoded image changes with pictures. And, in real-time encoding, speed of inputting pictures is usually determined such as 30 pictures per second or 60 pictures per second, and therefore, the image encoding synchronization processing unit 2600 processes pictures at the same processing time for each picture.

As shown in FIG. 10, the processing time from a picture not using the correlation between pictures to a next picture not using the correlation between pictures (from start of a Pic A processing to end of a Pic E processing in FIG. 10) is approximately the same in the bit stream encoding processing unit 2100 and the image encoding synchronization processing unit 2600. In practice, this relation has fluctuation, but the maximum number of bits (maximum bit rate) usable in the bit stream of the encoded image for one second is defined by the image compression technique standard and the number of pictures encoded in one second is normally determined in real-time encoding, and therefore, in a case where the bit rate of the encoded picture becomes maximum under these conditions, the processing time from a picture not using the correlation between pictures to the next picture not using the correlation between pictures becomes approximately the same in the bit stream encoding processing unit 2100 and the image encoding synchronization processing unit 2600.

That is, in a case where the bit stream encoding processing unit 2100 and the image encoding synchronization processing unit 2600 cannot be started independently and are operated in synchronization, it is necessary to operate the entire in accordance with the image encoding synchronization processing unit 2600 because of the number of pictures encoded in one second and it is necessary to design the bit stream encoding processing unit 2100 so as to process peak of a data amount per picture of a bit stream of the encoded image within the processing time of one picture.

And, since many processings in the bit stream encoding processing are performed in order from front and a parallel operation is difficult, in order to increase processing performance, normally the operation frequency must be increased. As a result, power consumption is increased. However, as explained in the present invention, if the bit stream encoding processing unit 2100 and the image encoding synchronization processing unit 2600 can be started independently, peak performance of the bit stream encoding processing unit 2100 can be suppressed and the operation frequency can be suppressed, as a result, the power consumption can be reduced.

Furthermore, the intermediate code is made in the same manner as that in the image decoding device 1000 and the operation frequency can be suppressed as the entire image encoding device in the same manner as in the image decoding device 1000, as a result, the power consumption can be reduced.

### Third Embodiment

With reference to FIG. 11, a structure and operation of an image decoding device according to a third embodiment of the present invention are explained. FIG. 11 is a structural diagram showing the structure of the image decoding device according to the third embodiment of the present invention and this is a structure in a case where the image decoding device 1000 is integrated in a system LSI.

Although a basic structure is the same as that of the image decoding device 1000 shown in FIG. 1 of the first embodiment, the memory control unit 800 is replaced with a system bus interface 870, and the system bus interface 870 is connected to a system bus 950. Further, the input/output unit 700 is omitted and the total control unit 600 is also connected to the system bus interface 870.

To the system bus 950, a memory interface 850 is connected, and the system bus 950 is connected to the memory 900 via the memory interface 850. Further, to the system bus 950, a processor 3000 is connected.

In the present embodiment, when the image decoding device 1000 performs reading and writing of the memory 900, it is performed via the system bus interface 870, the system bus 950 and the memory interface 850. And, since the total control unit 600 is connected to the system bus interface 870, start of the bit stream decoding processing unit 1100 and the image decoding synchronization processing unit 1600 can be controlled by accessing from a system bus 950 side.

The processor 3000 performs various processings of the system LSI. In the image decoding processing, the processor 3000 controls the image decoding device 1000 via the system bus 950, controls start timings of the bit stream decoding processing unit 1100 and the image decoding synchronization processing unit 1600 and performs memory management necessary for the image decoding processing.

And, the image encoding device 2000 can be integrated in a system LSI in the same manner.

That is, also in the image encoding device 2000, the memory control unit 800 is replaced with the system bus interface 870, the system bus interface 870 is connected to the system bus 950, the input/output unit 700 is omitted and the total control unit 600 is connected to the system bus interface 870. And, using the processor 3000, start timings of the bit stream encoding processing unit 2100 and the image encoding synchronization processing unit 2600 are controlled and memory management necessary for the image encoding processing is performed.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention relates to an image decoding device and an image encoding device decoding or encoding an image signal and can be applied widely to a digital broadcasting-related device and a device performing digital recording and reproducing of an image using an image encoding device and an image decoding device based on the image compression technique standard requiring reduction of an operation frequency and power consumption.

What is claimed is:

1. An image decoding device decoding image streams of a plurality of variable-length encoding methods comprising:
a bit stream decoding processing unit performing code decoding and analysis of image streams of a plurality of encoding methods to the image streams and generating an intermediate code;
a memory recording the image streams encoded and the intermediate code;
an image decoding synchronization processing unit generating a decoded image based on the intermediate code recorded in the memory; and
a total control unit controlling the bit stream decoding processing unit and the image decoding synchronization processing unit to operate in parallel.

2. The image decoding device according to claim 1,
wherein the bit stream decoding processing unit and the image decoding synchronization processing unit are started respectively by a unit corresponding to a picture structuring an image by the total control unit.

3. The image decoding device according to claim 2,
wherein the picture includes pictures having correlation between them and pictures having no correlation between them, and
wherein an operation frequency of the bit stream decoding processing unit is controlled so that time intervals of pictures having no correlation between them processed independently by the bit stream decoding processing unit and the image decoding synchronization processing unit become equal.

4. The image decoding device according to claim 1,
wherein the bit stream decoding processing unit comprises:
a variable-length code decoding unit decoding a bit sequence of a bit stream variable-length-encoded;
a syntax analysis unit determining an encoding method of a next coming bit sequence based on a syntax regulation of an encoding method; and
an intermediate code encoding unit generating the intermediate code of a bit sequence decoded based on an encoding method determined by the syntax analysis unit, and
wherein the variable-length code-decoding unit performs a decoding processing based on the encoding method obtained as an analysis result of the syntax analysis unit.

5. The image decoding device according to claim 1,
wherein the image decoding synchronization processing unit is composed of:
an intermediate code decoding unit decoding an intermediate code;
an intermediate code syntax analysis unit obtaining an encoding method of a next intermediate code based on a syntax regulation of an intermediate code; and
a decoding unit generating a decoded image, and
wherein the intermediate code decoding unit performs a decoding processing based on an encoding method obtained as an analysis result of a syntax analysis unit.

6. The image decoding device according to claim 1,
wherein the intermediate code stored in the memory is composed of portions of a prefix, a separator and a suffix, a maximum length of the prefix is defined according to a kind of a parameter and in a case where the prefix handles a value exceeding the maximum length, a value of the separator is changed and an encoding method of the suffix is changed.

7. An image encoding device performing an encoding processing of an image into an image stream by a plurality of variable-length encoding methods comprising:
an image encoding synchronization processing unit performing image encoding of an image to be encoded and generating an intermediate code;
a memory recording the intermediate code and the image to be encoded;
a bit stream encoding processing unit converting the intermediate code recorded in the memory into a bit stream code; and
a total control unit controlling the bit stream encoding processing unit and the image encoding synchronization processing unit to operate in parallel.

8. The image encoding device according to claim 7,
wherein the bit stream encoding processing unit and the image encoding synchronization processing unit are started respectively by a unit corresponding to a picture structuring an image by the total control unit.

9. The image encoding device according to claim 8,
wherein the picture includes pictures having correlation between them and pictures having no correlation between them, and
wherein an operation frequency of the bit stream encoding processing unit is controlled so that time intervals of pictures having no correlation between them processed independently by the bit stream encoding processing unit and the image encoding synchronization processing unit become equal.

10. The image encoding device according to claim 7,
wherein the image encoding synchronization processing unit comprises:
an image encoding unit encoding an image by a predetermined image compression method;
an intermediate code syntax generation unit performing syntax generation of an intermediate code format to compressed and encoded image information by a predetermined encoding method; and
an encoding unit encoding an intermediate code according to an encoding method of the intermediate code syntax generation unit.

11. The image encoding device according to claim 7,
wherein the bit stream encoding processing unit comprises:
a code decoding unit decoding the intermediate code;
a syntax generation unit performing syntax generation of an image stream according to an image compression method; and
a variable-length code encoding unit generating a bit stream of a variable-length code according to a method of syntax generation.

12. The image encoding device according to claim 7,
wherein the intermediate code stored in the memory is composed of portions of a prefix, a separator and a suffix, a maximum length of the prefix is defined according to a kind of a parameter and in a case where the prefix handles a value exceeding the maximum length, a value of the separator is changed and an encoding method of the suffix is changed.

13. An image decoding method of image streams of a plurality of variable-length encoding methods comprising:
a first step of analyzing a bit stream and generating a intermediate code of a stream; and
a second step of generating a decoded image based on the intermediate code,
wherein the first step and the second step are started by a unit corresponding to a picture structuring an image and executed in parallel.

14. The image decoding method according to claim 13,
wherein the picture includes pictures having correlation between them and pictures having no correlation, and
wherein a time interval of processings of pictures having no correlation between them in the first step is equal to a time interval of processings of pictures having no correlation between them in the second step.

15. The image decoding method according to claim 13,
wherein the first step comprises:
a step of decoding a bit sequence of a bit stream variable-length-encoded;
a step of determining an encoding method of a next coming bit sequence based on a syntax regulation of an encoding method; and
a step of generating an intermediate code of a bit sequence decoded based on an encoding method determined by the syntax analysis unit, and
wherein in the step of decoding a bit sequence, a bit sequence of a bit stream is decoded based on a determination result of the step of determining the encoding method of a bit sequence.

16. The image decoding method according to claim 13,
wherein the second step comprises:
a step of decoding the intermediate code;
a step of obtaining an encoding method of a next intermediate code based on a syntax regulation of an intermediate code; and
a step of generating a decoded image, and
wherein in the step of decoding the intermediate code, the intermediate code is decoded based on a result of a step of obtaining an encoding method of a next intermediate code.

17. An image encoding method of encoding an image by a plurality of variable-length encoding methods comprising:
a first step of performing image encoding of an image to be encoded and generating an intermediate code; and
a second step of performing bit stream encoding converting the intermediate code into a bit stream code,
wherein the first step and the second step are started by a unit corresponding to a picture structuring an image and executed in parallel.

18. The image encoding method according to claim 9,
wherein the picture includes pictures having correlation between them and pictures having no correlation, and
wherein a time interval of processings of pictures having no correlation between them in the first step is equal to a time interval of processings of pictures having no correlation between them in the second step.

19. The image encoding method according to claim 9,
wherein the first step comprises:
a step of encoding an image by a predetermined image compression method;
a step of performing syntax generation of an intermediate code format to compressed and encoded image information by a predetermined encoding method; and
a step of encoding an intermediate code according to an intermediate code syntax.

20. The image encoding method according to claim 9,
wherein the second step comprises:
a step of decoding the intermediate code;
a step of performing syntax generation of an image stream according to an image compression method; and
a step of generating a bit stream of a variable-length code according to a method of syntax generation.

21. A system LSI performing a decoding processing of image streams of a plurality of variable-length encoding methods comprising:
a bit stream decoding processing unit performing code decoding and analysis of image streams of a plurality of encoding methods to the image streams and generating an intermediate code;
a memory interface inputting and outputting the image streams encoded and the intermediate code;
an image decoding synchronization processing unit generating a decoded image based on the intermediate code inputted from the memory interface; and
a system bus interface having a processor controlling a start timing of a total control unit controlling the bit stream decoding processing unit and the image decoding synchronization processing unit to operate in parallel and connected.
